(19) United States
(12) Patent Application Publication
(10) Pub. No.: US 2006/0061942 A1
(43) Pub. Date: Mar. 23, 2006

(54) Piece of Furniture, Especially a Work Table

(75) Inventors: Mirko Abel, Villingen-Schwenningen-Tannheim (DE); Tilo Pulz, Spaichingen (DE)

Correspondence Address: GUDRUN E. HUCKETT DRAUDT, LONSSTR. 53, WUPPERTAL, 42289, DE

(73) Assignee: KESSEBOHMER PRODUKTIONS GMBH, Weilheim/Teck (DE)

(21) Appl. No.: 11/162,613

(22) Filed: Sep. 16, 2005

(30) Foreign Application Priority Data
Sep. 17, 2004 (DE) 20 2004 014 791.2

(51) Int. Cl. H02B 1/04

(52) U.S. Cl. 361/636

(57) ABSTRACT

A piece of furniture has a table top having an opening and a frame supporting the table top. A cover plate for closing the opening of the table top is provided. At least one height-adjustable holder for a work device is provided for moving the work device from a lowered rest position through the opening in the table top into a position of use above the table top and vice versa. The cover plate is connected to the holder and is moved by the holder from a closed position into an open position. The holder comprises a lifting device. The cover plate is pivotably connected to a back wall of the piece of furniture.

### BACKGROUND OF THE INVENTION

The invention relates to a piece of furniture, in particular a work table or desk, comprising a frame supporting at least one table top and further comprising at least one height-adjustable holder for a work device that can be moved from a lowered rest position through an opening in the table top, closable by at least one cover plate, into a position of use and vice versa.

Work tables or desks are known in which the cover plate is in the form of a part of the table top that can be pivoted upwardly into the open position. When the cover is folded upwardly, the opening is released so that the work device that is mounted on a holder can be lifted into a position of use above the table top. A disadvantage is that the cover must be moved by hand in a cumbersome way into the open or closed position.

### SUMMARY OF THE INVENTION

It is an object of the present invention to configure a piece of furniture of the aforementioned kind such that the work device can be moved between the position of use and a rest position in a simple way.

In accordance with the present invention, this is achieved in that the cover plate is movable by the holder from the closed position into the open position

As a result of the configuration according to the invention, the cover plate is moved by the holder of the work device into its open position. When the work device is returned into the rest position, the cover plate can be automatically returned into the closed position. A separate drive for the cover plate is not required. Further details are disclosed in the following description, the drawings, and the claims.

### BRIEF DESCRIPTION OF THE DRAWING

FIG. 1 is a perspective illustration of a piece of furniture according to the invention in the form of a work table, showing a work device in the form of a monitor arranged thereon that can be stowed in the work table.

FIG. 2 shows in a detail view a part of the work table in which the monitor is arranged showing the monitor in the rest position.

FIG. 3 is an illustration corresponding to FIG. 2 showing the monitor in a first intermediate position when being moved out of the rest position into the extended position.

FIG. 4 is an illustration corresponding to FIG. 2 showing the monitor in a second intermediate position when being moved out of the rest position into the extended position.

FIG. 5 is an illustration corresponding to FIG. 2 showing the monitor in the extended position (position of use).

FIG. 6 is an illustration corresponding to FIG. 5 showing the monitor in different tilted positions.

FIG. 7 shows the work table with the monitor in the rest (stowed) position.

### DESCRIPTION OF THE PREFERRED EMBODIMENTS

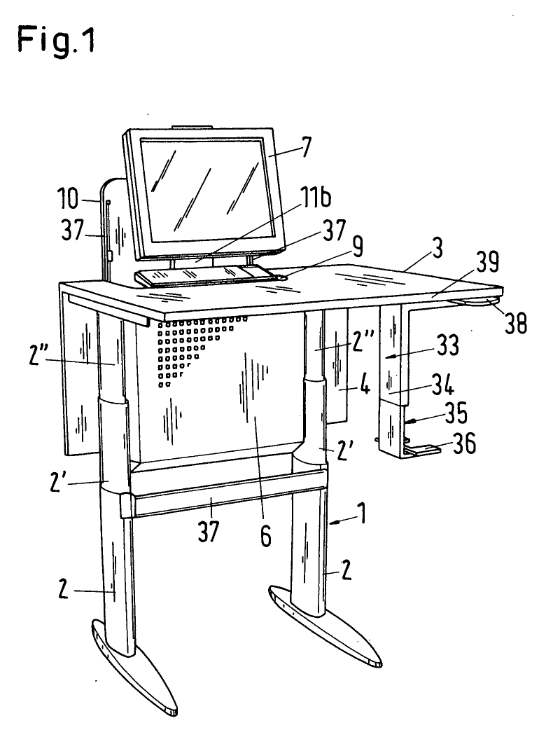

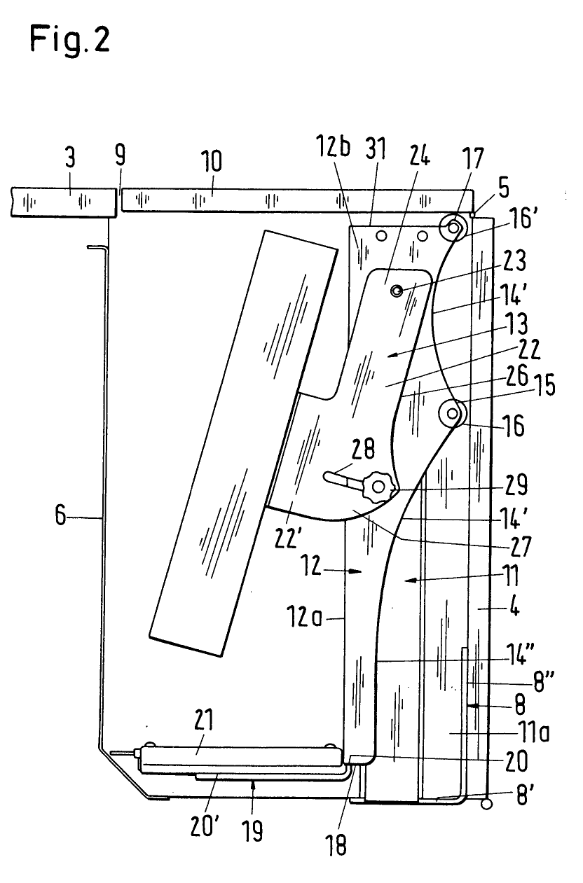

The work table or computer table/desk according to FIG. 1 fas a frame 1 with telescoping legs 2 comprised of telescoping tubes. A table top 3 is fastened to the frame 1. In the illustrated embodiment, the table top 3 and the back wall 4 are of a unitary configuration. In the area adjoining the back wall 4, the table top 3 has an opening 9 through which the work device 7, in the illustrated embodiment a monitor 7, can be moved between the rest position (stowed) and a position of use and vice versa. This opening 9 can be closed by cover part or plate 10. The cover plate 10 is, for example, pivotably supported by a hinge 5 on the upper inner edge of the back wall 4 (FIG. 2).

Between the neighboring upper telescoping leg sections 2′, 2″ of the legs 2, a panel 6 is provided that covers or hides the monitor 7 when in its rest position toward the front. The panel 6 is a plate or sheet that is fastened with its vertical edges to sidewalls that extend transversely away from the back wall 4. The panel 6 is open towards the top and the bottom. The panel 6 is covered in the upward direction by the table top 3 and the cover part 10.

In order to lift the monitor from its lowered rest position (FIG. 2) into its extended position or position of use (FIGS. 1, 5, 6) above the table top 3, a lifting device 11 is provided which is supported on the horizontal bracket leg 8′ of an L-shaped bracket 8 that is fastened to the lower edge of the back wall 4 with a vertical bracket leg 8″ in the area between the legs 2. The lifting device 11 is a lifting column with two telescoping tubes 11a, 11b of which the outer telescoping tube 11a is attached to the bracket leg 8′. The telescoping tubes 11a, 11b are advantageously rectangular tubes that have a high section modulus and therefore are able to move even a heavy monitor 7 up and down in a reliable fashion. Depending on the stroke length, more than two telescoping tubes can be provided.

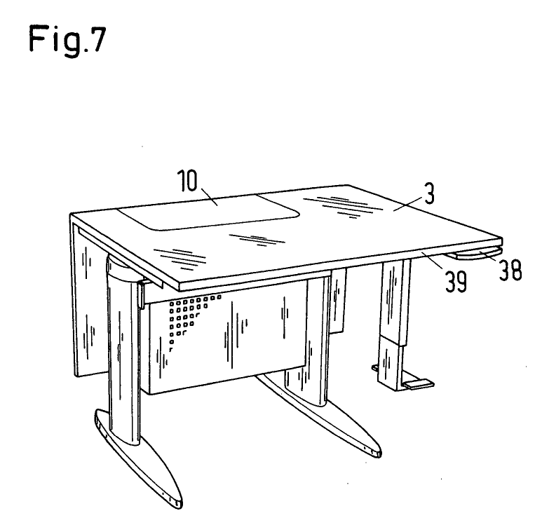

The cover plate 10 is designed such that in the closed position, i.e., the monitor 7 is lowered into its rest position, it is positioned in a common plane with the table top 3 and thus covers completely the opening 9 (FIG. 7).

On both narrow sides of the inner telescoping tube 11b, a support leg 12b of an upright U-shaped support 12 is attached, respectively. Each of the support legs 12b has a holding part in the form of a pivot arm 13 pivotably connected thereto for holding the monitor 7. The support 12 is fastened by means of a transverse stay 12a to the end face of the tube 11b that is facing away from the back wall 4 and by means of the support legs 12b to the narrow sides of the inner telescoping tube 11b. Each support leg 12b of the support 12 has an upper part that is wider than the telescoping tube 11b so that the support leg 12b of the support 12 projects past the telescoping tube 11b in a direction toward the back wall 4. The upper part of the support legs 12b is significantly wider than the lower part; the lower part of each support leg 12b is narrower than the telescoping tube 11b. The upper part of each support leg 12b is provided at their edges with two freely rotatable rollers 16, 16′ that are positioned at a spacing above one another. The rollers 16, 16′ are positioned at the facing inner sides of the support legs 12b of the support 12 and project in the direction toward the back wall 4 past the edge 14 of the support legs 12b. In the area between the two rollers 16, 16′, the edge 14 is concavely curved so that the rollers 16, 16′ are supported on the projecting edge sections 15, 17 of the support legs 12b that project in the direction toward the back wall 4. The edge section 17 moreover projects past the upper horizontal edge 31 of the support legs 12b, respectively.

Beginning at the lower roller 16, the width of the support legs 12b decreases in the downward direction toward the free end. An L-shaped supporting element 19 is attached between the support legs 12b to the lower horizontal edge 18 of the support 12. The end of the vertical short leg 20 is covered by the two support legs 12b and the transverse stay 12a of the support 12. The short leg 20 is fastened at a spacing to the telescoping tube 11a to the inner side of the transverse stay 12a of the support 12. The longer horizontal leg 20′ of the supporting element 19 projects past the support 12 and supports a tray 21 for writing utensils and the like. The tray 21 can be attached to the horizontal leg 20′ in a suitable way. It is advantageous to simply place the tray 21 onto the horizontal leg 20′ so that, as needed, it can be removed in a simple way. Advantageously, the tray 21 projects transversely to the lifting column 11 in the direction toward the front wall of the panel 6. The tray 21 can be divided into individual compartments. Of course, the tray 21 can also have any other suitable configuration. Instead of the tray 21, a keyboard of a personal computer can be arranged on the horizontal leg 20′.

When viewed in a side view, the pivot arms 13 are L-shaped arms. The long legs 22 are pivotably attached to the support legs 12b, respectively, in that in the area of the free ends 24 of the long legs 22 swivel pins 23 are provided that pass through the long legs 22 and serve to connect the pivot arms 13 pivotably on the upper parts of the support legs 12b of the support 12. The free ends 25 of the short legs 22′ of the pivot arms 13 are bent at a right angle such that securing tabs for the monitor 7 are formed.

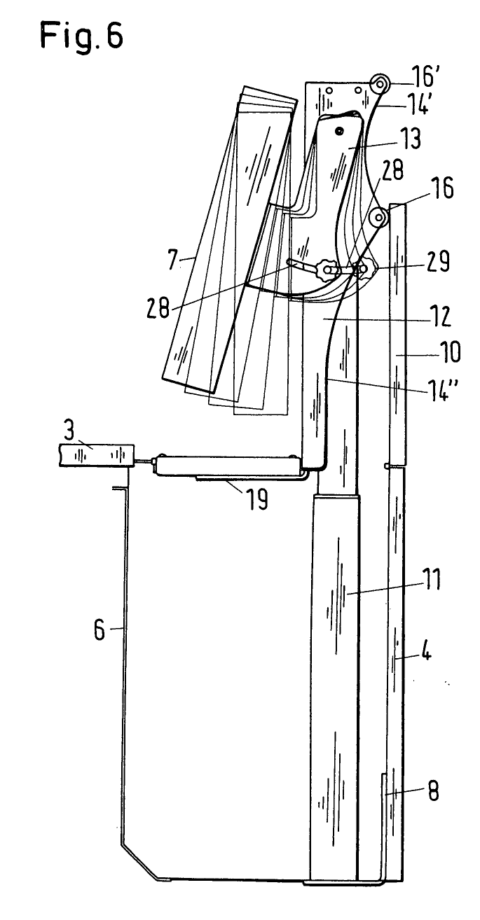

The short legs 22′ of the pivot arms 13 are wider for supporting the weight of the monitor 7 than the long legs 22 and have a widened portion 27 that project past the rear edge 26 of the long legs 22. A transversely positioned guide slot 28 is provided in the widened portion 27, respectively, through which a clamping device 29 projects, respectively. The clamping devices 29 can have any suitable configuration. In the drawings, the clamping devices 29 are illustrated as clamping screws in an exemplary fashion; they are screwed into threaded openings in the support legs 12b of the support 12. The guide slots 28 are curved at a great radius of curvature about the swivel axis of the swivel pins 23 and extend approximately across the entire width of the long legs 22. The monitor 7, as illustrated in FIG. 6, can be adjusted by means of the pivot arms 13 continuously in regard to its tilting angle in order to adjust it in the most beneficial work position. For this purpose, it is only necessary to loosen the clamping screws 29 on both pivot arms 13 when the monitor 7 is in the extended position. The monitor 7 can then be tilted into the desired position causing the pivot arms 13 to be pivoted also about the swivel axis of their swivel or bearing pins 23 wherein the axes of the clamping screws 29 glide within the guide slots 28. Then, the clamping screws 29 must only be tightened in the selected tilted position.

When no longer needed, the monitor 7 can be moved into its rest position (FIG. 2 and FIG. 7) in which it is completely lowered into the work table. The cover plate 10 closes the opening 9 and is positioned flush with the table top 3. Accordingly, the entire table top 3 can be used when the monitor 7 is in the lowered rest position. In the position of rest, the rollers 16, 16′ have minimal spacing relative to the back wall 4 and the cover plate 10.

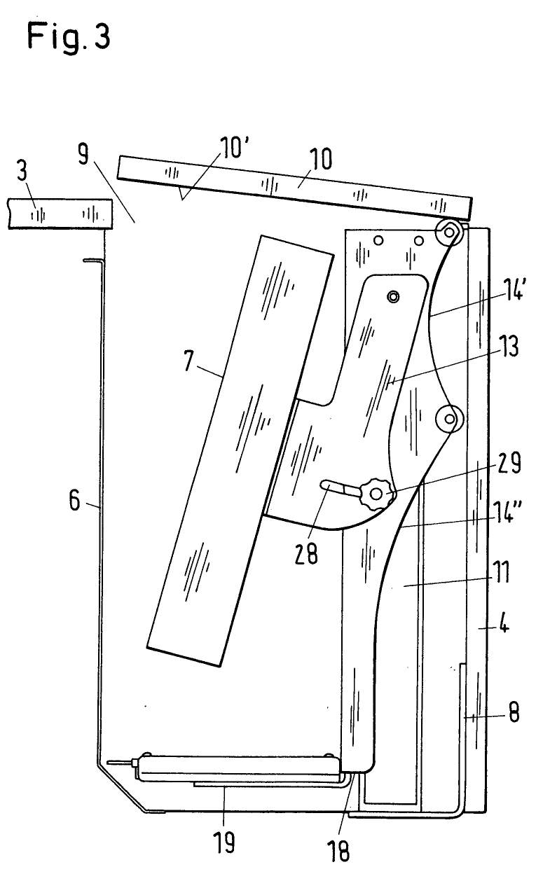

In order to move the monitor 7 from its lowered rest position (FIG. 1, 2) in the upward direction into the position of the use above the table top 3, the lifting cylinder 11 is actuated by a drive that is not illustrated. The inner telescoping tube 11b is extended. The support 12 and the pivot arms 13 are accordingly entrained. Already after a short lifting stroke, the upper rollers 16′ contact near the hinge 5 the underside of the cover plate (FIG. 3). Upon further extension of the telescoping tube 11b, the cover plate 10 is pivoted upwardly by the rollers 16′. During the first lifting phase, the lower rollers 16 are spaced from the back wall 4. Since the rollers 16′ are freely rotatable, they can roll without problems on the underside of the cover plate 10 during the opening process.

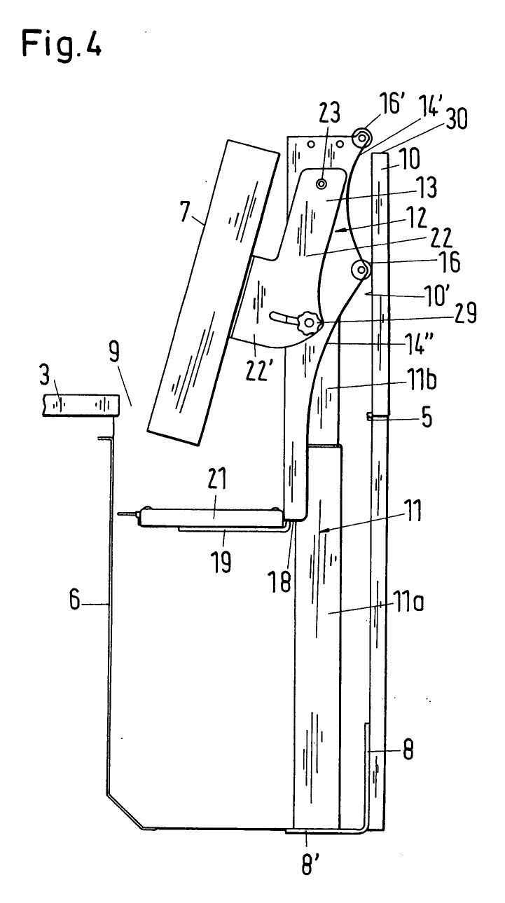

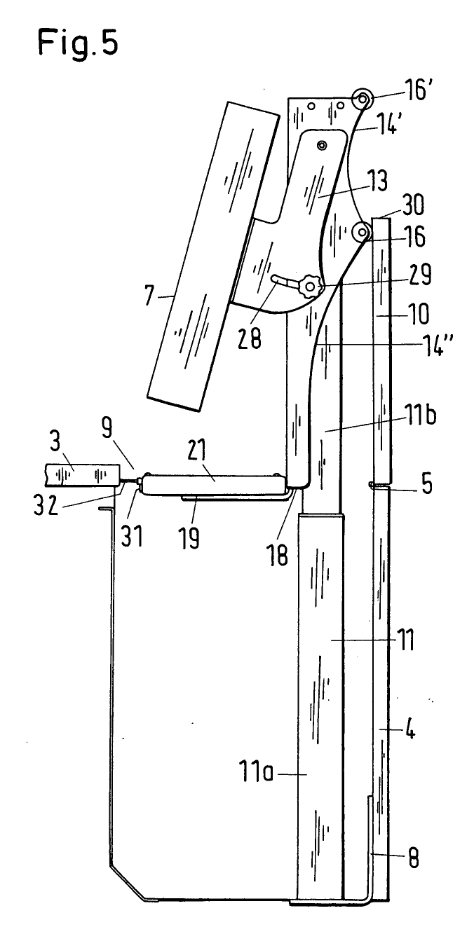

The spacing between the rollers 16, 16′ is smaller than the length of the cover plate 10 measured in the lifting direction. Accordingly, during the course of the lifting stroke the lower rollers 16 also contact the cover plate 10. The cover plate 10 is then held and pivoted upwardly by all rollers 16, 16′. As soon as the cover plate 10 has reached an almost vertical position, the upper rollers 16′ release the cover plate 10 and the lower rollers 16 are located approximately at half the height of the cover plate 10 (FIG. 4). In this position, the monitor 7 is not yet completely extended. The telescoping tube 11b continues to move upwardly. The rollers 16 secure the cover plate 10 in the open position. In the completely extended position (FIG. 5), the lower rollers 16 are positioned at a minimal spacing below the upper edge 30 of the cover plate 10. The monitor 7 is positioned in the area above the table top 3. The tray 21 is positioned in the area of the opening 9 and closes substantially completely the opening 9 in the area between the support 12 and the edge opposite the back wall 4.

On the edge 31 of the tray 21 facing away from the support 12, a sealing strip 32 (FIG. 5) is attached that covers the narrow gap between the tray 21 and the neighboring edge of the opening 9. The sealing strip 32 is advantageously elastic so that it can close the gap reliably even in the case of assembly tolerances.

In the position illustrated in FIGS. 2 to 5, the monitor 7 is pivoted into an end position in which the clamping device 29 rests at the end of the guide slot 28 facing the cover plate 10 and the monitor 7 is pivoted rearwardly to the maximum extent. From this position, the monitor 7 can be continuously pivoted into different tilting positions, is illustrated in FIGS. 6. In its second end position, in which the clamping device 29 is in the area of the second end of the guide slot 28, the monitor 7 is substantially vertical or upright.

In order to lower the monitor 7 into the rest position, the telescoping tube 11b is retracted. The rollers 16 secure the cover plate 10 in the vertical open position. Before the rollers 16 reach the back wall 4, the upper rollers 16′ contact the inner side of the cover plate 10 and keep it in the open position. In accordance with the downward rolling movement of the rollers 16′ along the cover plate 10 in the direction toward the back wall 4, the cover plate 10 pivots downwardly under its own weight in the direction toward its closed position. Shortly before the rollers 16′ roll from the cover plate 10 onto the inner side of the back wall 4, the cover plate 10 is almost in its covering or closed position (FIG. 3). When the rollers 16′ reach the back wall 4, the cover plate 10 pivots without creating any noise into its horizontal closed position (FIG. 2). Advantageously, at least one brake cylinder 37 (FIG. 1) is connected to the inner side of the cover plate 10; the brake cylinder 37 is pivotably supported on the inner side of the back wall 4. In the illustrated embodiment, the cover plate 10 is supported at both narrow sides by a brake cylinder 37, respectively. The braking force is advantageously adjustable so that it is matched optimally to the weight of the cover plate 10. When using such a brake cylinder 37, the retraction speed of the telescoping tube 11b can be high because in this case the cover plate 10 must not be supported by means of the rollers 16, 16′ during the return pivot action. Since such brake cylinders are known to a person skilled in the art, their configuration and function will not disclosed in any detail in this context.

The monitor 7 is attached to the pivot arms 13 such that it does not project upwardly passed the support 12. In this way, it is spaced from the cover plate 10 in the lowered position (FIG. 2). During the extension and retraction movements, the monitor 7 always has a spacing from the cover plate 10 because of the disclosed configuration. In the lowered position, the monitor 7 is protected behind the panel 6. The tray 21 covers and protects the monitor 7 from below.

As illustrated in FIG. 1, on the bottom side of the table top 3 adjacent to the frame 1 an L-shaped carrier 33 for a computer is mounted. At least the vertical leg 34 of the carrier 33 is a hollow member in which an L-shaped rest 35 is height-adjustable arranged. A computer is supported on the horizontal leg 36. The rest 35 can be secured as is known in the art at the vertical leg 34 at a selected height. The computer is secured as is known in the art. The carrier 33 and the rest 35 form a clamping fixture with which the computer can be secured by clamping as is known in the art.

For reinforcing the frame 1, the legs 2 are connected to one another by at least one transverse brace 40 (FIG. 1).

For the height adjustment of the table top 3 and of the monitor 7, an electric drive is provided, respectively. Advantageously, these drives have a common control that can be actuated by means of a control panel 38 that is advantageously arranged in an area accessible by a person located in front of the table top 3. In the illustrated embodiment, the control panel 38 is provided at the front edge 39 of the table top 3. It can be designed so as to be movable into a position underneath the table top 3.

In the disclosed embodiment, the support 12 is U-shaped. Instead of such a single support, it is possible to arranged on the narrow sides of the inner telescoping tube 11b of the lifting device 11 supports 12 that are embodied as angle sections.

While specific embodiments of the invention have been shown and described in detail to illustrate the inventive principles, it will be understood that the invention may be embodied otherwise without departing from such principles.

What is claimed is:

1. A piece of furniture comprising:
a table top having an opening;
a frame supporting the table top;
a cover plate for closing the opening of the table top;
at least on height-adjustable holder for a work device for moving the work device from a lowered rest position through the opening in the table top into a position of use above the table top and vice versa;
wherein the cover plate is connected to the holder and is moved by the hlder from a closed position into an open position.

2. The piece of furniture according to claim 1, wherein the holder comprises a lifting device.

3. The piece of furniture according to claim 1, wherein the holder comprises at least one gliding member and rests, when being moved, with the at least one gliding member against the cover plate.

4. The piece of furniture according to claim 3, wherein the at least one gliding member is a freely rotatable roller.

5. The piece of furniture according to claim 3, wherein several of the at least one gliding member are provided.

6. The piece of furniture according to claim 5, wherein the several gliding members are arranged at a spacing adjacent to one another; above one another; or adjacent and above one another.

7. The piece of furniture according to claim 3, wherein the holder has at least one support on which the at least one gliding member is arranged.

8. The piece of furniture according to claim 7, wherein the at least one gliding member is located on a rear edge of the support.

9. The piece of furniture according to claim 8, wherein the rear edge of the support has projecting edge sections and wherein the at least one gliding member is arranged on the projecting edge sections.

10. The piece of furniture according to claim 8, wherein the rear edge of the support is concavely curved in an area between two of the at least one gliding member.

11. The piece of furniture according to claim 7, wherein the holder further comprises at least one holding part for the work device, wherein the at least one holding part is connected to the support.

12. The piece of furniture according to claim the 11, wherein the at least one holding part is an L-shaped arm.

13. The piece of furniture according to claim 11, wherein the at least one holding part is pivotably supported on the support.

14. The piece of furniture according to claim 11, wherein the at least one holding part is adjustable relative to the support for adjusting a tilting angle of the work device.

15. The piece of furniture according to claim 14, wherein the at least one holding part comprises at least one clamping device.

16. The piece of furniture according to claim 15, wherein the at least one holding part has a guide slot that is curved about a swivel axis of the holding part.

17. The piece of furniture according to claim 16, wherein the clamping device is a clamping screw.

18. The piece of furniture according to claim 17, wherein the clamping screw passes through the guide slot.

19. The piece of furniture according to claim 7, wherein the at least one support comprises at least one supporting element for tray for utensils, wherein the at least one supporting element is connected to a lower edge of the support.

20. The piece of furniture according to claim 19, wherein the supporting element is L-shaped.

21. The piece of furniture according to claim 19, wherein the tray, when the work device is in the position of use, fills substantially the opening between the support and an edge of the opening remote from the support and is positioned in a common plane with the table top.

22. The piece of furniture according to claim 19, wherein the tray, when the work device is in the position of use, fills substantially the opening between the support and an edge of the opening remote from the support or is positioned in a common plane with the table top .

23. The piece of furniture according to claim 2, further comprising a back wall connected to the table top.

24. The piece of furniture according to claim 23, wherein the back wall extends only across a portion of a height of the frame.

25. The piece of furniture according to claim 24, further comprising at least one bracket connected to a lower edge of the back wall, wherein the lifting device is supported on the at least one bracket.

26. The piece of furniture according to claim 25, wherein the at least one bracket is L-shaped.

27. The piece of furniture according to claim 25, wherein the at least one bracket has a first leg connected to the back wall and a second leg extending substantially horizontally, wherein the lifting device is connected to the second leg.

28. The piece of furniture according to claim 23, further comprising a panel connected to the back wall for covering the work device when in the rest position.

29. The piece of furniture according to claim 28, wherein the panel covers a side of the work device facing away from the back wall and optionally covers the work device laterally.

30. The piece of furniture according to claim 28, wherein the panel is positioned between adjacently positioned legs of the frame.

31. The piece of furniture according to claim 1, wherein the cover plate is pivotably supported.

32. The piece of furniture according to claim 31, wherein the cover plate is pivotably connected to the back wall.

33. The piece of furniture according to claim 1, wherein the holder comprises a lifting device, wherein the table top and the lifting device each have a drive, wherein a common control for the two drives is provided.

34. The piece of furniture according to claim 33, wherein at least one control panel is provided for actuating the common control.

35. The piece of furniture according to claim 34, wherein the at least one control panel is arranged in an area accessible for a person positioned at the piece of furniture.

36. The piece of furniture according to claim 34, wherein the at least one control panel is arranged on a front edge of the table top.

37. The piece of furniture according to claim 34, wherein the at least one control panel is movable into a rest position underneath the table top.

38. The piece of furniture according to claim 1, wherein the opening is a cutout of the table top.
